(19) United States
(12) Patent Application Publication
(10) Pub. No.: US 2026/0255214 A1
(43) Pub. Date: Aug. 27, 2026

(54) METHOD AND APPARATUS FOR CONGESTION CONTROL ENHANCEMENTS ON STAND-ALONE NON-PUBLIC NETWORK PROVIDING ACCESS FOR LOCALIZED SERVICES

(71) Applicant: MEDIATEK INC., Hsinchu City (TW)

(72) Inventors: Chia-Lin LAI, Hsinchu City (TW); Yuan-Chieh LIN, Hsinchu City (TW)

(73) Assignee: MEDIATEK INC., Hsinchu City (TW)

(21) Appl. No.: 19/472,774

(22) PCT Filed: Aug. 27, 2024
(86) PCT No.: PCT/CN2024/114698

§ 371 Date: Oct. 6, 2025

Related U.S. Application Data
(60) Provisional application No. 63/584,922, filed on Sep. 25, 2023.

(51) Int. Cl. H04W 28/02; H04W 48/18

(52) U.S. Cl. CPC H04W 28/0289; H04W 48/18

(57) ABSTRACT

Various solutions for congestion control enhancements on stand-alone non-public network (SNPN) providing access for localized services are described. A network apparatus may receive a request message from a user equipment (UE). Then, the network apparatus may determine whether a non-access stratum (NAS) level congestion control is active and whether an SNPN associated with the network apparatus provides access for localized services. In an event that the NAS level congestion control is active and the SNPN provides access for localized services, the network apparatus may transmit a reject message to the UE. The reject message may include a cause value not indicating congestion and may not include a back-off timer value.

### CROSS REFERENCE TO RELATED PATENT APPLICATION(S)

The present disclosure is part of a non-provisional application claiming the priority benefit of U.S. Patent Application No. 63/584,922, filed 25 Sep. 2023, the content of which herein being incorporated by reference in its entirety.

TECHNICAL FIELD The present disclosure is generally related to mobile communications and, more particularly, to congestion control enhancements on stand-alone non-public network (SNPN) providing access for localized services.

### BACKGROUND

Unless otherwise indicated herein, approaches described in this section are not prior art to the claims listed below and are not admitted as prior art by inclusion in this section.

A public land mobile network (PLMN) is a network established and operated by an administration or recognized operating agency (ROA) for the specific purpose of providing land mobile communication services to the public. PLMN provides communication possibilities for mobile users. A PLMN may provide service in one or a combination of frequency bands. Access to PLMN services is achieved by means of an air interface involving radio communications between mobile phones and base stations with integrated IP network services. One PLMN may include multiple radio access networks (RANs) utilizing different radio access technologies (RATs) for accessing mobile services. RAN is part of a mobile communication system, which implements a radio access technology. Conceptually, RAN resides between a mobile device and provides connection with its core network (CN). Depending on the (3^{rd} Generation Partnership Project (3GPP)) standards, mobile phones and other wireless connected devices are varyingly known as user equipment (UE), terminal equipment (TE), mobile stations (MS), or mobile termination (MT), etc. Examples of different RATs include 2^{nd} generation (2G) Global System for Mobile Communications (GSM), 3^{rd} generation (3G) Universal Mobile Telecommunications System (UMTS), 4^{th} generation (4G) Long Term Evolution (LTE), 5th generation (5G) New Radio (NR), and other non-3GPP access RAT including Wireless Fidelity (Wi-Fi).

As compared to PLMN, a non-public network (NPN) is a network for non-public use. An NPN is either a stand-alone NPN (SNPN), i.e., operated by an NPN operator and not relying on network functions provided by a PLMN, or a public network integrated NPN (PNI-NPN), i.e., an NPN deployed with the support of a PLMN. A Credentials Holder (CH) may authenticate and authorize access to an SNPN separate from the CH. The combination of a PLMN ID and Network identifier (NID) identifies an SNPN.

Local or localized services are services that are provided locally (e.g., at specific/limited area and/or are bounded in time). A localized service provider is an application provider or a network operator who make their services localized and to be offered to end user via a hosting network (e.g., an SNPN or a PNI-NPN). A hosting network is a network that provides (access for) localized services, while a home network is a network owning the currently in-use subscription or credential of the UE. In general, an SNPN may provide localized services where the services may be accessed by UE/user at specific time (duration/period) and/or location. End user may enable or disable to access localized services. If the end user enables to access localized services, the UE (i.e., MS) may access an (S)NPN providing access for localized services. Otherwise, if the end user disables to access localized services, the UE (i.e., MS) may not access an (S)NPN providing access for localized services.

In 3GPP Release 18, it is agreed that the standards for 5G NR will support localized services, but details of how the 3GPP standards should be adapted with respect to UE and NW operations are unclear and still under discussion. For example, general NAS level congestion control should also be applicable to SNPNs. However, in current design of NAS level congestion control, if a UE accesses an SNPN that provides access for localized services but the SNPN is under congestion (e.g., a huge amount of requests sent by multiple UEs may result in control signals storming to the SNPN), the mobility management (MM) control node of the SNPN should reject the UE's access request and configure a back-off timer to the UE to defer the UE's request in the SNPN. With the back-off timer running, the UE is not allowed to reselect to another network. Later on, when the back-off timer is expired, the time may have exceeded the specific time (duration/period) indicated in the time validity information of the SNPN. As a result, the UE will have to stay in the congested SNPN where it is unable to access any localized services. Unfavorably, this would degrade user experience.

Therefore, there is a need to provide proper schemes to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to congestion control enhancements on SNPN providing access for localized services. It is believed that the above-described issue would be avoided or otherwise alleviated by implementing one or more of the proposed schemes described herein.

In one aspect, a method may involve a network apparatus receiving a request message from a UE. The method may also involve the network apparatus determining whether a NAS level congestion control is active and whether an SNPN associated with the network apparatus provides access for localized services. The method may further involve the network apparatus transmitting a reject message to the UE in an event that the NAS level congestion control is active and the SNPN provides access for localized services, wherein the reject message comprises a cause value not indicating congestion and does not comprise a back-off timer value.

In one aspect, a network apparatus may comprise a transceiver which, during operation, enables communications with a UE. The network apparatus may also comprise a processor communicatively coupled to the transceiver. The processor, during operation, may perform operations comprising receiving, via the transceiver, a request message from the UE. The processor may also perform operations comprising determining whether a NAS level congestion control is active and whether an SNPN associated with the network apparatus provides access for localized services. The processor may further perform operations comprising transmitting, via the transceiver, a reject message to the UE in an event that the NAS level congestion control is active and the SNPN provides access for localized services, wherein the reject message comprises a cause value not indicating congestion and does not comprise a back-off timer value.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication system providing access for localized services in accordance with implementations of the present disclosure.

FIG. 2 is a diagram depicting two example scenarios of a 5G system (5GS) architecture with access to an SNPN using credentials from a CH.

FIG. 3 is a diagram depicting an example scenario of NAS level congestion control for SNPNs providing access for localized services in accordance with the legacy design.

FIG. 4 is a diagram depicting another example scenario of NAS level congestion control for SNPNs providing access for localized services in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to congestion control enhancements on SNPN providing access for localized services. According to the present disclosure, a number of possible solutions may be implemented separately or jointly. That is, although these possible solutions may be described below separately, two or more of these possible solutions may be implemented in one combination or another.

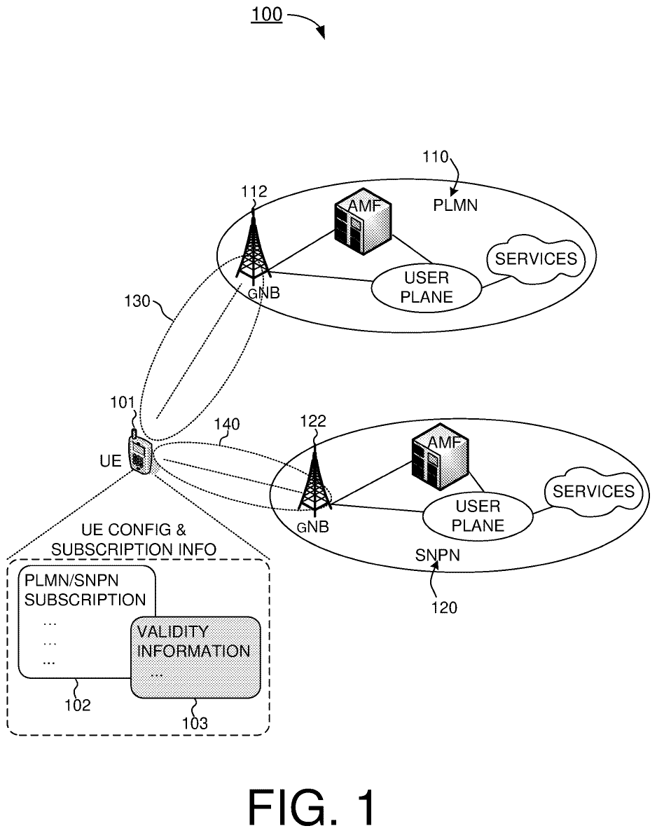

FIG. 1 illustrates an example scenario 100 of a communication system providing access for localized services in accordance with implementations of the present disclosure. Scenario 100 involves a communication system including a UE 101, a PLMN 110 and an SNPN 120 providing access for localized services. The PLMN 110 may include control plane functionalities (e.g., an access and mobility management function (AMF)), user plane functionalities (e.g., a user plane function (UPF)), and applications that provide various services by communicating with a plurality of UEs including UE 101. A serving base station (BS) (e.g., a Next Generation Node-B (gNB), or a transmission/reception point (TRP)) 112 belongs to part of the RAN 130. The RAN 130 provides radio access for the UE 101 via a RAT.

The SNPN 120 may include control plane functionalities (e.g., an AMF), user plane functionalities (e.g., a UPF), and applications that provides various services by communicating with a plurality of UEs including UE 101. The combination of a PLMN ID and NID identifies an SNPN. A serving BS (e.g., a gNB/TRP) 122 belongs to part of the RAN 140. The RAN 140 provides radio access for the UE 101 via a RAT. An AMF in the SNPN 120 may communicate with gNB 122. The SNPN 120 may be operated by an NPN operator and does not rely on network functions provided by a public network. A CH may authenticate and authorize access to an SNPN separate from the CH. Next-generation RAN (NG-RAN) nodes which provide access to SNPNs may broadcast information that includes: (i) one or multiple PLMN IDs; and (ii) a list of NIDs per PLMN ID identifying the (S)NPNs which the NG-RAN provides access to. An SNPN-enabled UE may be configured with PLMN ID and NID (i.e., configured with an SNPN ID=PLMN ID+NID) of the subscribed SNPN. An SNPN-enabled UE that supports access to an SNPN using credentials from a CH may additionally be configured with information for SNPN selection (SNPN selection information/configuration), and may perform registration using the PLMN/SNPN subscription 102 (e.g., stored in a universal subscriber identity module (USIM)) (in SNPN access mode).

Local or localized services are services that are provided locally (e.g., at specific/limited area and/or are bounded in time (e.g., specific time period(s), such as specific date(s) or specific hours of date(s)). The services may be realized via applications (e.g., live or on-demand audio/video stream, electric game, IP multimedia subsystem (IMS), etc.), or connectivity (e.g., UE to UE, UE to Data Network, etc.). A localized service provider may be an application provider or a network operator who makes their services localized and to be offered to end user via a hosting network. A hosting network may be a network that provides access for localized services and can be an SNPN or a PNI-NPN, while a home network is a network owning the currently in-use subscription or credential of the UE. In scenario 100, the SNPN 120 is the hosting network providing access for localized services to the UE 101.

A UE route selection policy (URSP) rule may include an association of the UE application and the DNN or network slice which is meant for a specific localized service. A URSP rule can also include “Route Selection Validity Criteria” (Time Window and/or a Location Criteria Validity Conditions) with the time/location defined for the specific localized service. The LADN (Local Access Data Network) can also be used for enabling the UE access to localized service.

To enable the SNPN 120 to provide access for localized services, the SNPN operator may configure the network with information enabling the UEs to access the localized services according to validity information of the localized services, and the information is determined in agreement with the localized service provider. For instance, the validity information may include: (i) identification of each localized service, e.g., to be used in URSP rules; and (ii) validity criteria/restriction for each localized service, e.g., the validity of time period and/or (area of) location.

When localized services in a network are completed, all UEs registered with the network are expected to be moved to other networks or to other cells within the same network. The other networks may each be a home PLMN (HPLMN), visited PLMN (VPLMN) or another SNPN. A UE may stop using the network resources for localized services for numerous reasons, such as (i) localized services in a network are completed; (ii) validity information of network selection information are no longer met; (iii) the user decides to stop using the localized services before they are completed (e.g., end user disables to access localized services); and (iv) a policy decision is taken by the network, with the effect that the UE is deregistered before the localized services are completed. The validity information 103 (or called validity restrictions, criteria, or conditions) is provided or configured to the UE 101 as part of the localized service information in UE configuration and subscription information, which is used to restrict the UE's access of an SNPN providing access for localized services. The validity information may include time validity information and/or location validity information associated with SNPN (ID) or GIN. For example, time validity information may indicate time period(s) (e.g., defined by start time and end time) when access to the SNPN for localized services is allowed, and location validity information may include geolocation information and/or tracking area information of serving networks, e.g., lists of tracking area codes (TACs) per PLMN ID or per PLMN ID and NID.

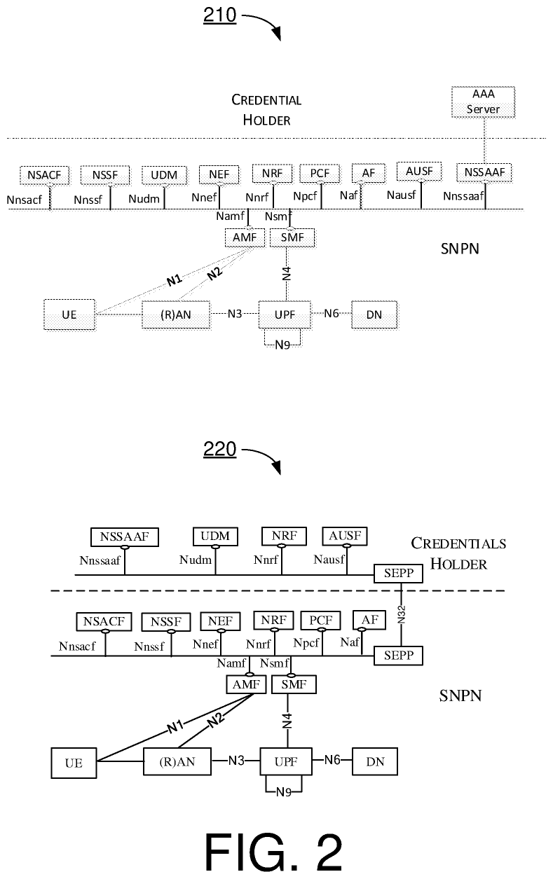

FIG. 2 illustrates two example scenarios 210 and 220 of a 5GS architecture with access to an SNPN using credentials from a CH. Scenario 210 depicts the 5GS architecture for SNPN with CH using authentication, authorization and accounting (AAA) server for primary authentication and authorization. The authentication server function (AUSF) and unified data management (UDM) in an SNPN may support primary authentication and authorization of UEs using credentials from an AAA server in a CH. The SNPN, as depicted by 210, can be the subscribed SNPN for the UE (i.e., the NG-RAN broadcasts the SNPN ID of the subscribed SNPN). As a deployment option, the SNPN, as depicted by 210, can also be another SNPN than the subscribed SNPN for the UE (i.e., none of the SNPN IDs broadcast by the NG-RAN matches the SNPN ID corresponding to the subscribed SNPN). The network slice-specific and SNPN authentication and authorization function (NSSAAF) deployed in the SNPN can support primary authentication in the SNPN using credentials from a CH using an AAA server (as depicted) and/or the NSSAAF can support NSSAAF with a network slice-specific AAA server (not depicted).

Scenario 220 depicts the 5GS architecture for SNPN with CH using AUSF and UDM for primary authentication and authorization. An SNPN may support primary authentication and authorization of UEs that use credentials from a CH using AUSF and UDM. The CH may be an SNPN or a PLMN. The CH UDM provides to SNPN the subscription data.

Under certain proposed schemes in accordance with the present disclosure, when the NAS level congestion control is active, the AMF of the current SNPN that provides access for localized services may reject the UE's request message (e.g., a 5GMM signaling request such as a registration request or a service request) by replying to the UE with a reject message to allow the UE to perform SNPN selection (i.e., to select another SNPN providing access for localized services). Specifically, the reject message includes a cause value (e.g., a 5GMM cause value) not indicating congestion (e.g., #74 “Temporarily not authorized for this SNPN”, or #75 “Permanently not authorized for this SNPN”) and does not include an MM back-off timer (e.g., T3346) value. Accordingly, by applying the schemes of the present disclosure, the UE may be prevented from staying in a congested SNPN where the UE is unable to access localized services.

In some implementations, the AMF may determine whether the UE is accessing the SNPN for localized services (i.e., whether the current SNPN is an SNPN selected for localized services in SNPN) based on one of the following information: (i) a configuration locally maintained in the SNPN; (ii) information provided by the UE via a signaling between the UE and the SNPN; and (iii) information provided by the network function (e.g., UDM) of the UE's home network (e.g., subscribed SNPN).

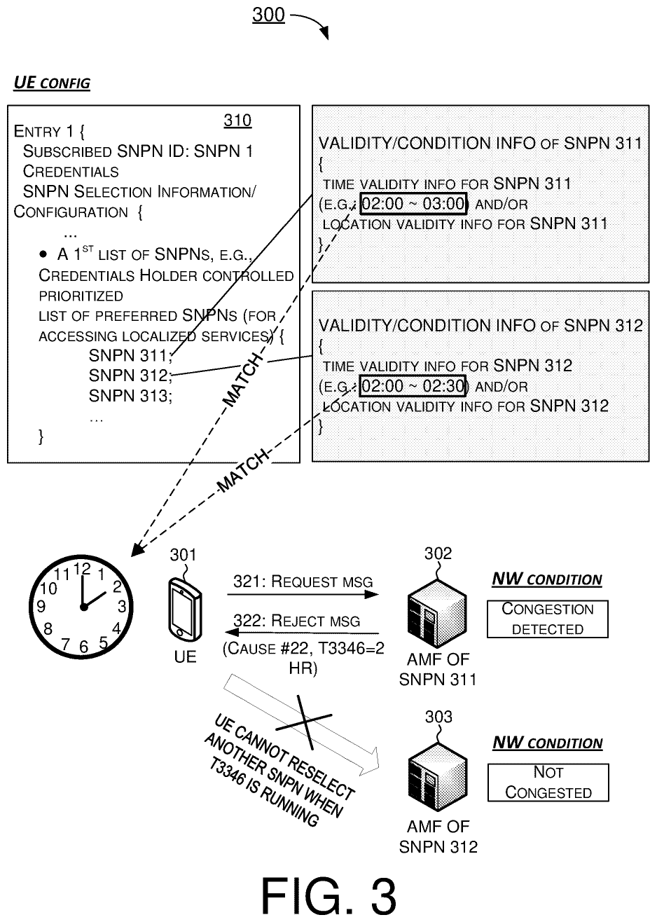

FIG. 3 illustrates an example scenario 300 of NAS level congestion control for SNPNs providing access for localized services in accordance with the legacy design. Scenario 300 involves an SNPN-enabled UE 301 configured with SNPN subscription 310 including: (i) the subscribed SNPN=SNPN 1; and (ii) CH-controlled prioritized list of preferred SNPNs (for accessing localized services), which includes SNPN 311, SNPN 312, and SNPN 313. Specifically, SNPN 311 is associated with time validity information/condition of 02:00~03:00, and SNPN 312 is associated with time validity information/condition of 02:00~02:30. Through AMF 302 and NG-RAN (not shown), the hosting network broadcasts its SNPN ID==311, with an indication that access using credentials from a CH is supported. Since the UE 301 is subscribed to SNPN 1, and SNPN 311 is included as a preferred SNPN in the entry of “list of subscriber data” for SNPN1, the UE 301 may select and attempt to access SNPN 311 using credentials from SNPN 1. Then, since there exists time validity information/condition for SNPN 311, the UE 301 needs to determine whether such time validity information/condition is met before accessing SNPN 311. As shown in FIG. 3, the UE 301 checks the current time being 02:00, which is inside the time period of 02:00~03:00. As such, the UE 301 attempts to access SNPN 311 by transmitting a registration or service request message 321 to the AMF 302 of SNPN 311. Additionally, or optionally, if location validity information is available, in this example we assume location validity condition is met per the location validity information. However, due to detecting 5GMM signaling congestion in SNPN 311, the AMF 302 rejects the UE's request by replying to the UE 301 with a registration or service reject message 322 including a 5GMM cause #22 “congestion” and an MM back-off timer T3346=2 hours. Upon receiving the registration or service reject message 322, the UE 301 starts T3346 with the received timer value (i.e., 2 hours) and is not allowed to initiate 5GMM signaling procedure with SNPN 311. Moreover, when T3346 is running, the UE 301 is not allowed to reselect another SNPN (e.g., SNPN 312), even though there is SNPN 312 which is available for providing access for localized services and is associated with time validity information (i.e., 02:00~02:30) that is met for the UE 301. Consequently, the UE 301 will have to stay in SNPN 311 from 02:00 to 04:00, where no service from SNPN 311 can be obtained, and by the time when T3346 expires (e.g., at 04:00), the UE 301 still cannot obtain any service from SNPN 311 since the valid time period (i.e., 02:00 to 03:00) for accessing SNPN 311 has passed.

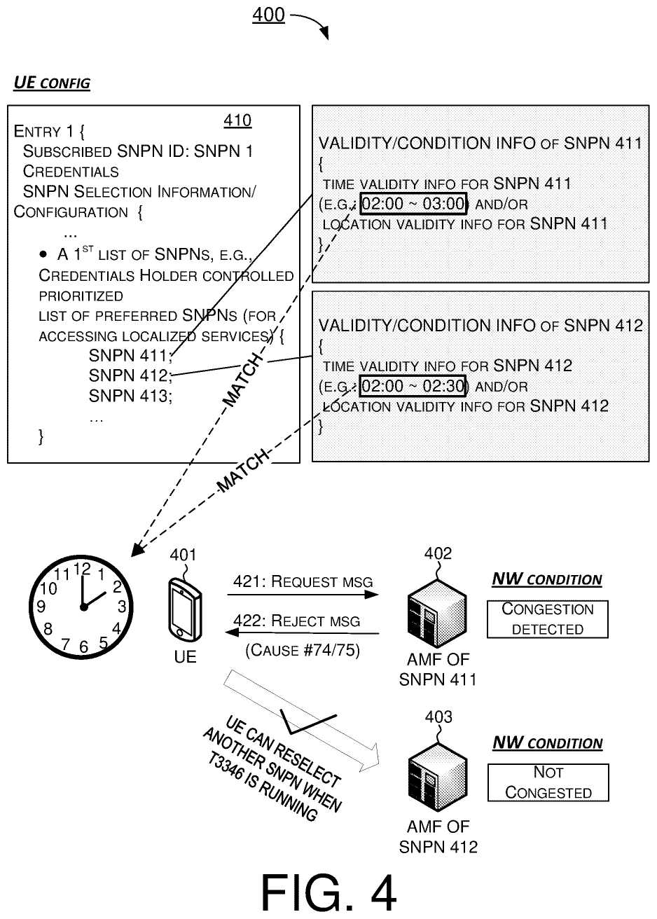

FIG. 4 illustrates an example scenario 400 of NAS level congestion control for SNPNs providing access for localized services in accordance with an implementation of the present disclosure. Scenario 400 involves an SNPN-enabled UE 401 configured with SNPN subscription 410 including: (i) the subscribed SNPN=SNPN 1; and (ii) CH-controlled prioritized list of preferred SNPNs (for accessing localized services), which includes SNPN 411, SNPN 412, and SNPN 413. Specifically, SNPN 411 is associated with time validity information/condition of 02:00~03:00, and SNPN 412 is associated with time validity information/condition of 02:00~02:30. Through AMF 402 and NG-RAN (not shown), the hosting network broadcasts its SNPN ID ==411, with an indication that access using credentials from a CH is supported. Since the UE 401 is subscribed to SNPN 1, and SNPN 411 is included as a preferred SNPN in the entry of “list of subscriber data” for SNPN1, the UE 401 may select and attempt to access SNPN 411 using credentials from SNPN 1. Then, since there exists time validity information/condition for SNPN 411, the UE 401 needs to determine whether such time validity information/condition is met before accessing SNPN 411. As shown in FIG. 4, the UE 401 checks the current time being 02:00, which is inside the time period of 02:00~03:00. As such, the UE 401 attempts to access SNPN 411 by transmitting a registration or service request message 421 to the AMF 402 of SNPN 411. Additionally, or optionally, if location validity information is available, in this example we assume location validity condition is met per the location validity information. Unlike AMF 302, responsive to detecting 5GMM signaling congestion in SNPN 411, the AMF 402 rejects the UE's request by replying to the UE 401 with a registration or service reject message 422 including an appropriate cause value other than 5GMM cause #22 “congestion” (e.g., #74 “Temporarily not authorized for this SNPN”, or #75 “Permanently not authorized for this SNPN”) and not including an MM back-off timer (e.g., T3346) value. Upon receiving the registration or service reject message 422, the UE 401 enters state 5GMM-REGISTERED. PLMN-SEARCH or 5GMM-DEREGISTERED. PLMN-SEARCH and performs SNPN selection to reselect another SNPN that provides access for localized services. In this example, there is SNPN 412 which is available for providing access for localized services and is associated with time validity information (i.e., 02:00~02:30) that is met for the UE 401. Accordingly, the UE 401 selects SNPN 412 to access for localized services. Assuming that SNPN 412 is not congested and decides to accept the UE's access request, the UE 401 can obtain localized services from SNPN 412 at least in the time period of 02:00~02:30.

### Illustrative Implementations

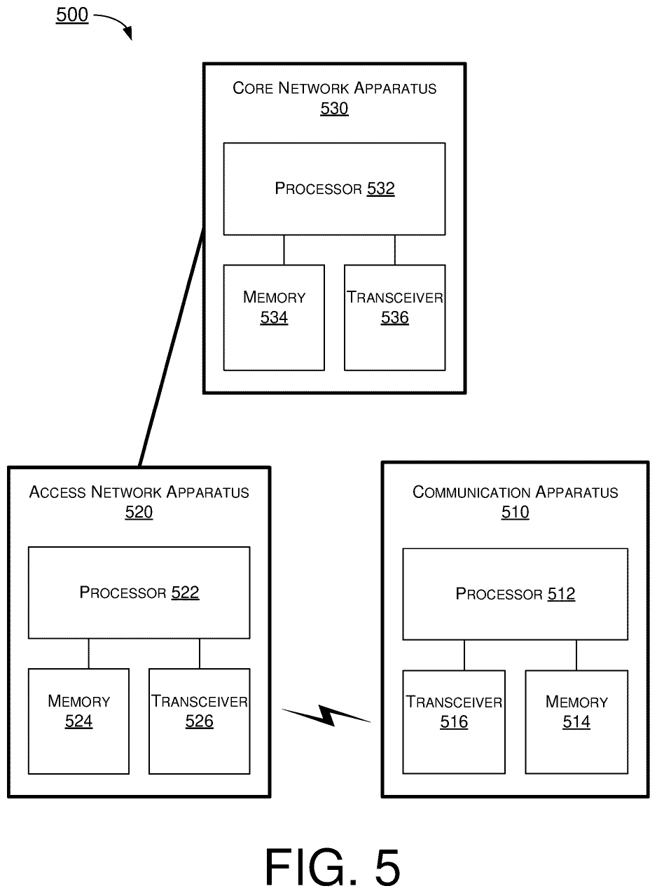

FIG. 5 illustrates an example communication system 500 having an example communication apparatus 510, an example access network apparatus 520, and an example core network apparatus 530 in accordance with an implementation of the present disclosure. Each of communication apparatus 510, access network apparatus 520, and core network apparatus 530 may perform various functions to implement schemes, techniques, processes and methods described herein pertaining to congestion control enhancements on SNPN providing access for localized services, including scenarios/schemes described above as well as process 600 described below.

Communication apparatus 510 may be a part of an electronic apparatus, which may be a UE (e.g., an SNPN-enabled UE) such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Access network apparatus 520 may be a part of an electronic apparatus, which may be a network node such as a base station, a small cell, a router, a gateway, or a satellite, providing radio access communications with communication apparatus 510 for core network apparatus 530. For instance, access network apparatus 520 may be implemented in an eNodeB in an LTE, LTE-Advanced or LTE-Advanced Pro network, or in a gNB or a TRP in a 5G NR, IoT, NB-IoT, or IIoT network, or in a satellite or a BS in a 6G network. Alternatively, access network apparatus 520 may be implemented in the form of one or more IC chips such as, for example and without limitation, one or more single-core processors, one or more multi-core processors, or one or more RISC or CISC processors. Access network apparatus 520 may include at least some of those components shown in FIG. 5 such as a processor 522, for example. Access network apparatus 520 may further include one or more other components not pertinent to the proposed scheme of the present disclosure (e.g., internal power supply, display device and/or user interface device), and, thus, such component(s) of access network apparatus 520 are neither shown in FIG. 5 nor described below in the interest of simplicity and brevity.

Core network apparatus 530 may be a part of an electronic apparatus, which may be a network node providing some core network functions, at least including the AMF for implementing schemes, techniques, processes and methods described herein pertaining to congestion control enhancements on SNPN providing access for localized services. For instance, core network apparatus 530 may be implemented in the form of one or more IC chips such as, for example and without limitation, one or more single-core processors, one or more multi-core processors, or one or more RISC or CISC processors. Core network apparatus 530 may include at least some of those components shown in FIG. 5 such as a processor 532, for example. Core network apparatus 530 may further include one or more other components not pertinent to the proposed scheme of the present disclosure (e.g., internal power supply, display device and/or user interface device), and, thus, such component(s) of core network apparatus 530 are neither shown in FIG. 5 nor described below in the interest of simplicity and brevity.

In one aspect, each of processor 512, processor 522, and processor 532 may be implemented in the form of one or more single-core processors, one or more multi-core processors, or one or more CISC processors. That is, even though a singular term “a processor” is used herein to refer to processor 512, processor 522, and processor 532, each of processor 512, processor 522, and processor 532 may include multiple processors in some implementations and a single processor in other implementations in accordance with the present disclosure. In another aspect, each of processor 512, processor 522, and processor 532 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 532 is a special-purpose machine specifically designed, arranged and configured to perform specific tasks including congestion control enhancements on SNPN providing access for localized services in a device (e.g., as represented by communication apparatus 510) and a network node (e.g., as represented by core network apparatus 530) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, access network apparatus 520 may also include a transceiver 526 coupled to processor 522 and capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications. In some implementations, core network apparatus 530 may also include a transceiver 536 coupled to processor 532 and capable of wired transmitting and receiving data, and, more particularly, capable of enabling communications with communication apparatus 510 via access network apparatus 520.

In some implementations, communication apparatus 510 may further include a memory 514 coupled to processor 512 and capable of being accessed by processor 512 and storing data (e.g., UE configuration and subscription information) therein. In some implementations, access network apparatus 520 may further include a memory 524 coupled to processor 522 and capable of being accessed by processor 522 and storing data therein. In some implementations, core network apparatus 530 may further include a memory 534 coupled to processor 532 and capable of being accessed by processor 532 and storing data (e.g., UE configuration and subscription information) therein. Each of memory 514, memory 524, and memory 534 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514, memory 524, and memory 534 may include a type of read-only memory (ROM) such as mask ROM, programmable ROM (PROM), erasable programmable ROM (EPROM) and/or electrically erasable programmable ROM (EEPROM). Alternatively, or additionally, each of memory 514, memory 524, and memory 534 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and core network apparatus 530 may be a communication entity capable of communicating with each other using various proposed schemes in accordance with the present disclosure. For illustrative purposes and without limitation, a description of capabilities of communication apparatus 510, as a UE, and core network apparatus 530, as a network node (e.g., AMF), is provided below with process 600.

### Illustrative Processes

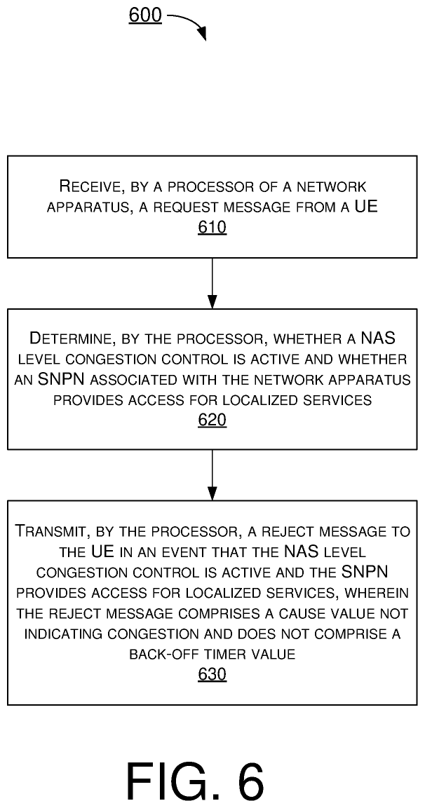

FIG. 6 illustrates an example process 600 in accordance with an implementation of the present disclosure. Process 600 may be an example implementation of above scenarios/schemes, whether partially or completely, with respect to congestion control enhancements on SNPN providing access for localized services. Process 600 may represent an aspect of implementation of features of core network apparatus 530. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by core network apparatus 530 or any suitable core network function for mobility management. Solely for illustrative purposes and without limitation, process 600 is described below in the context of core network apparatus 530. Process 600 may begin at block 610.

At 610, process 600 may involve processor 532 of core network apparatus 530 receiving, via transceiver 536, a request message from communication apparatus 510. Process 600 may proceed from 610 to 620.

At 620, process 600 may involve processor 532 determining whether a NAS level congestion control is active and whether an SNPN associated with core network apparatus 530 provides access for localized services. Process 600 may proceed from 620 to 630.

At 630, process 600 may involve processor 532 transmitting, via transceiver 536, a reject message to communication apparatus 510 in an event that the NAS level congestion control is active and the SNPN provides access for localized services, wherein the reject message comprises a cause value not indicating congestion and does not comprise a back-off timer value.

In some implementations, the cause value may include a 5GMM cause value indicating that the UE is temporarily or permanently not authorized for the SNPN.

In some implementations, the back-off timer may be T3346.

In some implementations, the reject message may be transmitted to allow communication apparatus 510 to select another SNPN providing access for localized services.

In some implementations, core network apparatus 530 may include an AMF.

In some implementations, the determining of whether the SNPN provides access for localized services is performed based on one of the following: (i) a configuration locally maintained in the SNPN; (ii) information provided by the UE via a signaling between the UE and the SNPN; and (iii) information provided by the network function (e.g., UDM) of the UE's home network (e.g., subscribed SNPN).

In some implementations, the request message may be a registration request or a service request.

In some implementations, the request message may be received in an event that validity information associated with the SNPN is met.

In some implementations, the validity information may be met when the validity information includes time validity information, and the time validity information indicates at least one time period matching communication apparatus 510's current time.

In some implementations, the validity information may be met when the validity information includes at least one of time validity information and location validity information, the time validity information indicates at least one time period matching communication apparatus 510's current time, and the location validity information indicates at least one geographical location or tracking area matching communication apparatus 510's current location.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a network apparatus, a request message from a user equipment (UE);
determining, by the processor, whether a non-access stratum (NAS) level congestion control is active and whether a stand-alone non-public network (SNPN) associated with the network apparatus provides access for localized services; and
transmitting, by the processor, a reject message to the UE in an event that the NAS level congestion control is active and the SNPN provides access for localized services, wherein the reject message comprises a cause value not indicating congestion and does not comprise a back-off timer value.

2. The method of claim 1, wherein the cause value comprises a 5^{th} generation mobility management (5GMM) cause value indicating that the UE is temporarily or permanently not authorized for the SNPN.

3. The method of claim 1, wherein the back-off timer is T3346.

4. The method of claim 1, wherein the reject message is transmitted to allow the UE to select another SNPN providing access for localized services.

5. The method of claim 1, wherein the network apparatus comprises an access and mobility management function (AMF).

6. The method of claim 1, wherein the determining of whether the SNPN provides access for localized services is performed based on one of the following:
a configuration locally maintained in the SNPN;
information provided by the UE via a signaling between the UE and the SNPN; and
information provided by a home network of the UE.

7. The method of claim 1, wherein the request message is a registration request or a service request.

8. The method of claim 1, wherein the request message is received in an event that validity information associated with the SNPN is met.

9. The method of claim 8, wherein the validity information is met when the validity information comprises time validity information, and the time validity information indicates at least one time period matching the UE's current time.

10. The method of claim 8, wherein the validity information is met when the validity information comprises at least one of time validity information and location validity information, the time validity information indicates at least one time period matching the UE's current time, and the location validity information indicates at least one geographical location or tracking area matching the UE's current location.

11. A network apparatus, comprising:
a transceiver which, during operation, enables communications with a user equipment (UE); and
a processor communicatively coupled to the transceiver such that, during operation, the processor performs operations comprising:
receiving, via the transceiver, a request message from the UE;
determining whether a non-access stratum (NAS) level congestion control is active and whether a stand-alone non-public network (SNPN) associated with the network apparatus provides access for localized services; and
transmitting, via the transceiver, a reject message to the UE in an event that the NAS level congestion control is active and the SNPN provides access for localized services, wherein the reject message comprises a cause value not indicating congestion and does not comprise a back-off timer value.

12. The network apparatus of claim 11, wherein the cause value comprises a 5^{th} generation mobility management (5GMM) cause value indicating that the UE is temporarily or permanently not authorized for the SNPN.

13. The network apparatus of claim 11, wherein the back-off timer is T3346.

14. The network apparatus of claim 11, wherein the reject message is transmitted to allow the UE to select another SNPN providing access for localized services.

15. The network apparatus of claim 11, wherein the network apparatus comprises an access and mobility management function (AMF).

16. The network apparatus of claim 11, wherein the determining of whether the SNPN provides access for localized services is performed based on one of the following:
a configuration locally maintained in the SNPN;
information provided by the UE via a signaling between the UE and the SNPN; and
information provided by a home network of the UE.

17. The network apparatus of claim 11, wherein the request message is a registration request or a service request.

18. The network apparatus of claim 11, wherein the request message is received in an event that validity information associated with the SNPN is met.

19. The network apparatus of claim 18, wherein the validity information is met when the validity information comprises time validity information, and the time validity information indicates at least one time period matching the UE's current time.

20. The network apparatus of claim 18, wherein the validity information is met when the validity information comprises at least one of time validity information and location validity information, the time validity information indicates at least one time period matching the UE's current time, and the location validity information indicates at least one geographical location or tracking area matching the UE's current location.
